(19) United States
(12) Patent Application Publication
(10) Pub. No.: US 2016/0280572 A1
(43) Pub. Date: Sep. 29, 2016

(54) POLYMERS FOR FLOCCULATION, DEWATERING AND CONSOLIDATION OF OIL SANDS FLUID FINE TAILINGS, MINE TAILINGS AND SOLID PARTICULATE SUSPENSIONS

(71) Applicant: THE GOVERNORS OF THE UNIVERSITY OF ALBERTA, Edmonton (CA)

(72) Inventors: Hongbo ZENG, Edmonton (CA); Bin YAN, Edmonton (CA); Qiuyi LU, Edmonton (CA); Qi LIU, Edmonton (CA)

(73) Assignee: THE GOVERNORS OF THE UNIVERSITY OF ALBERTA, Edmonton (CA)

(21) Appl. No.: 14/826,677

(22) Filed: Aug. 14, 2015

Related U.S. Application Data
(60) Provisional application No. 62/139,134, filed on Mar. 27, 2015.

(51) Int. Cl. C02F 1/56; C02F 11/12

(52) U.S. Cl. CPC C02F 1/56; C02F 11/12; C02F 2103/10

(57) ABSTRACT

A method of treating a solid particulate suspension, such as fluid fine tailings, to form a flocculated slurry by mixing with the suspension with a polymer having a solubility in water which is temperature responsive, having an upper critical solution temperature between about 0° C. and about 80° C. The polymer may be formed from water-soluble monomer units and monomers units which are insoluble or less-soluble in water than the water-soluble monomers. When used with mature fine tailings (MFT), reclaimable MFT may be formed by dewatering the treated slurry.

### CROSS REFERENCE TO RELATED APPLICATIONS

This application claims the priority benefit of U.S. Provisional Patent Application No. 62/139,134 filed on Mar. 27, 2015 entitled “Polymers for Flocculation, Dewatering and Consolidation of Oil Sands Fluid Fine Tailings, Mine Tailings and Solid Particulate Suspensions”, the contents of which are incorporated herein by reference.

### FIELD OF THE INVENTION

This invention relates to flocculation, dewatering and consolidation of solid particulate suspensions such as fluid fine tailings or mature fine tailings generated from water-based bitumen extraction processes from oil sands, and other mine tailings.

### BACKGROUND

Considerable oil reserves around the world are locked in the form of oil sands, also called tar or bitumen sands. Oil sands from the Athabasca region in Canada generally comprise water-wet sand grains and clays held together by a matrix of viscous heavy oil or bitumen. Conventional bitumen extraction processes use hot water to mined oil sands to separate the bitumen from the mixture but yields large volumes of tailings composed of sand, fine silts, clays and residual bitumen. When the tailings are discharged to the tailings ponds, the sands settle to form a beach while the fine solids and residual bitumen form a dilute thin fine tailings (TFT) in the tailings ponds. The TFT can be treated by flocculants in thickeners to form the thickened tailings (TT), but generally they are left in the tailings ponds, and, after months and years, the TFT settle substantially into three layers. The top layer consisting primarily of water is recycled back to the extraction process. The middle layer comprises a stable suspension of fine clay and residual bitumen in water. Over long period of time, the middle layer becomes denser, creating mature fine tailings (MFT) which has an average solid content of approximately 30-40 wt %. The bottom layer consists essentially of sand. Further water release from the MFT takes decades and therefore, large tailings ponds are required to contain the MFT. After about 50 years of oil sands production, the tailings ponds in the Fort McMurray region of northern Alberta now occupy more than 176 km² of lands.

The thin fine tailings (TFT), thickened tailings (TT), and mature fine tailings (MET), are collectively called fluid fine tailings (ITT) by the oil sands industry.

FFT behaves as a fluid colloidal-like material. The fact that FFT behaves as a fluid and have very slow dewatering and consolidation rates limits options to reclaim tailings ponds. A challenge facing the industry remains the removal of water from the FFT to increase the solids content well beyond 35% and strengthen the deposits to the point that they can be reclaimed and no longer require containment. Therefore, it is desirable to find ways to flocculate and dewater the fines, and to consolidate the sediments so that the water can be recycled back to the extraction process and the oil sands tailings can be reclaimed.

According to Directive 074 issued by the Energy Resources Conservation Board of Alberta, FFT should be captured and converted into trafficable deposits by achieving a minimum undrained shear strength of 5 kPa within 1 year of deposition, and 10 kPa to be ready for reclamation with 5 years after active deposition has ceased.

A number of technologies have been proposed and some are in commercial use for the treatment of the oil sands tailings, such as composite tailings (CT) technology, the freeze-thaw cyclic treatment, and the tailings reduction operation (TRO) which combines polymer flocculation with thin lift deposition. However, none can effectively dewater MFT directly. To achieve acceptable outcomes on treating MFT, the existing methods usually require additional pre-treatment steps such as dilution or adding coarse sands. Other methods like freeze-thaw cyclic treatment demonstrated its effectiveness in dewatering MFT on a small scale, but it is difficult to scale up and its final performance is highly dependent on weather and seasonal variations. Furthermore, the outcomes of all of these existing methods are highly dependent on process conditions such as the ways to add and mix chemicals with MFT, and the natural drying conditions via evaporation, which makes most of these methods delicate and unreliable.

Given the significant and growing inventory of FFT, and MFT in particular, and a lack of effective methods to dewater and densify the FFT, there is a need in the art for innovative technologies that can enable cost-effective and fast dewatering, consolidation and densification of solid particular suspension such as FFT and MFT.

### SUMMARY OF THE INVENTION

The present invention relates to methods and compositions for dewatering, consolidation and densification of solid particulate suspensions. In one embodiment, the solid particular suspension may comprise mine tailings or oil sands fluid fine tailings (FFT), and mature fine tailings (MFT) in particular. In one embodiment, more specifically, the solid particulate suspensions can be densified into trafficable deposits. In the context of MFT, the solid particulate suspension may be dewatered and densified into a reclaimable material, preferably with a minimum un-drained shear strength of 10 kPa, which has developed in a time frame of less than about 3 weeks.

Therefore in one aspect, the invention may comprise a method of treating a Solid particulate suspension to form a flocculated slurry, comprising the steps of mixing the suspension with a polymer having a solubility in water which is temperature responsive, having an upper critical solution temperature between about 0° C. and about 80° C.

In one embodiment, the polymer may comprise water-soluble monomer units and monomers units which are insoluble or less-soluble in water than the water-soluble monomers and further may have a content of less soluble or insoluble monomer constituents between about 1 to about 50 mol %, preferably between about 5 to about 30 mol %. The polymer has a weight-average molecular weight between about 5000 and about 3×10⁷ Dalton, preferably greater than about 1×10⁶ Dalton. The less-soluble or insoluble monomer may be one that is at least 20% less soluble than the water-soluble monomer it is combined with, and preferably at least 30% or 50% less soluble than the water-soluble monomer it is combined with.

In one embodiment, in the case of a slurry comprising MFT, the method may further comprise the step of producing a reclaimable MFT by slope deposition, gravity settling, filtration, screening, high pressure grinding roller (HPGR) compression, or other mode of compression, or combinations thereof. The reclaimable MFT may have a solids content greater than about 70% (wt.) and/or a shear strength greater than about 10 kPa, which may be produced within 3 weeks.

In one embodiment, the polymer is added to the MFT without any pre-treatment of the MFT.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 Schematic diagram illustrating the conceptual processes to dewater and densify the oil sands fluid fine tailings (FFT), including mature fine tailings (MFT), using the polymer flocculants for water recycle and land reclamation.

FIG. 2 Photographs showing the states of untreated MFT A (left) and treated MFT A using Polymer A (right). The untreated MFT A (left) is a thick homogeneous solids-water mixture. The Polymer A treated MFT A (right) shows apparent phase separation between clear released water phase and solid phase after adding Polymer A.

FIG. 3 Photographs showing water release of treated MFT on a kitchen strainer (left) and the separated water and dewatered MFT after the kitchen strainer separation (right).

FIG. 4 Photographs showing the treatment of 300 g of MFT A with Polymer A: treated MFT in the beaker with released water after adding Polymer A (left); the beaker contents were transferred on a kitchen strainer (middle); and the appearance of the dewatered MFT on the kitchen strainer after 30 min (right).

FIG. 5 Photographic demonstration of an experimental compression setup to further densify dewatered MFT composing of a steel mesh filter (aperture diameter 1-3 mm); a container; and weights of total mass of 4.2 kg for compression. With this setup, the dewatered MFT can be densified to above 70 wt % solids with an un-drained shear strength of greater than 10 kPa under 0.15 atmospheric pressure.

FIG. 6 Photographs showing the resulting compressed cakes (“reclaimable MFT”) after compressing 150 g dewatered MFT A under 0.15 atmospheric pressure for one day (left) and 14 days (right), using the setup shown in FIG. 5.

FIG. 7 Changes in solid contents of dewatered MFT after compression in the setup shown in FIG. 5 under 0.15 atmospheric pressure (up to 100 min).

FIG. 8 Changes in solid contents of dewatered MFT after compression in the setup shown in FIG. 5 under 0.15 atmospheric pressure (up to 14 days).

FIG. 9 Photographs showing Polymer A treated MFT on a lab vacuum filtration setup.

FIG. 10 Net water release from the polymer-treated MFT using the vacuum filtration setup in FIG. 9. Note: after ˜20 mins, cracks were formed in the filter cake, and the vacuum dropped to zero, at which point the net water release from the MFT reached 40-50%.

FIG. 11 Photographs showing continuous water release of the dewatered MFT in sealed jars under gravity sedimentation.

FIG. 12 Solid content of dewatered MFT in sealed jars under gravity sedimentation shown in FIG. 11.

FIG. 13 Shear strength of dewatered MFT as a function of solid content after 7 days of 0.15 bar pressure.

FIG. 14 A graph showing visible light (550 nm) transmittance of a 0.5 wt % solution of Polymer A in water, as a function of temperature.

### DETAILED DESCRIPTION

As used herein, certain terms have the meanings defined below. All other terms and phrases used in this specification have their ordinary meanings as one of skilled in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

In one aspect, the dewatering and densification processes described herein addresses treatment of oil sands fluid fine tailings (FFT), and mature fine tailings (MFT) in particular, with a flocculating polymer. In one embodiment, the polymers are dissolved or dispersed in un-diluted MFT. A large fraction of clear water is released immediately upon mixing the polymer with the MFT to produce a dewatered MFT. Generally the net water release from MFT within 30 min is about 35-50%, and the dewatered MFT reaches an un-drained shear strength of about 5 kPa or higher within about 24 hours.

As used herein, “treated MFT” or “flocculated MFT” is the MFT that has been mixed with a certain dosage of a polymer flocculant. “Dewatered MFT” is the MFT that has been treated with a certain dosage of the polymer flocculant, resulting in water release, after the released water has been removed by decantation or straining. “Reclaimable MFT” is the treated MFT that has been dewatered and densified by filtration, compression, or various other means to achieve a solid content of over 70 wt % and/or a shear strength of greater than about 10 kPa.

As used herein, mineral fractions with a particle diameter less than 44 μm are referred to as “fines.” Fines are typically quartz and clay mineral particles in suspension, predominantly kaolinite and illite. Sand particles are solids of mineral fractions with a particle diameter greater than 44 μm.

“Oil sands fluid fine tailings” or oil sands FFT refer to tailings derived from oil sands extraction containing different fines fractions, which consist of the thin fine tailings (TFT), thickened tailings (TT), and/or mature fine tailings (MFT) which are formed in the tailings ponds, or their mixtures. The typical solid content of MFT may range from 10 wt % to 55 wt %, and the fines content may range from 30% to 100% of the total solids. “Solid content” is the ratio of the weight of solids to that of the original weight of tailings slurry. In the present invention, the weight of solids is obtained after drying the treated sediments at 100° C. for 24 hr.

After removing the released water, the dewatered MFT may be further treated to release water. For example, the dewatered MFT may be deposited on a slope and will continue to release water in a short period of time (2-3 weeks) under gravity sedimentation. Alternatively, the dewatered MFT sediment may be filtered or subjected to mild compression which causes faster dewatering and generates a sediment cake that can be reclaimed with solid content greater than about 70 wt % and shear strength greater than 10 kPa.

One embodiment of a method for dewatering and densifying MFT is shown conceptually in FIG. 1. The process comprises the step of dissolving or dispersing the flocculating polymers in MFT under vigorous mixing. The polymer-flocculated or dewatered MFT can then be deposited onto a dewatering slope so that the solids will settle and the water will run off. Alternatively, the polymer-flocculated MFT can be filtered to separate water from the solids. Alternatively, or in addition, the dewatered MFT may be compressed to release more water and to form a solid-state sediment which can be transported by devices such as belt conveyors for stacking and reclamation.

In one embodiment, the flocculating polymers described herein may be used singly or in combination, or in combination with other polymers.

In a preferred embodiment, several possible results may be achieved: 1) immediate net water release from MFT upon the addition (mixing) of the flocculating polymer; 2) the polymer flocculated MFT may possess properties that are conducive to further dewatering, consolidation and densification by utilizing relatively simple and easy processes widely used in the industry; 3) a solids content of above 70 wt % may be achievable in a relatively short period of time (about 3 weeks or less), so that the MFT will have passed its plasticity limit and can be reclaimed; 4) sediment may have a minimum shear strength of 10 kPa, achieved within a relatively short time period (about 3 weeks or less) to meet or exceed the demand of Directive 074 to accelerate the reclamation process of MFT.

In one embodiment, the polymers are directly dispersed or dissolved in MFT to produce flocculated slurries (“treated MFT”), wherein a mild mechanical mixing is applied to allow the generation of a homogeneous mixture of the polymer and the MFT. In one embodiment, the treated MFT releases about 20% to about 35% of the original water in about 10 min, and releases about 35% to about 50% of the original water in about 30 min without any further treatment, and continues to release water beyond 30 min.

After removing the released water, the dewatered MFT may have a solid content of about 40 wt % to about 45 wt %. Gravity settling alone may further densify the dewatered MFT to a solid content of about 50 to about 60 wt % in 1 to 2 weeks. The un-drained shear strength of the dewatered MFT instantly increases from 30 Pa for the original untreated MFT to over 1 kPa upon addition of the flocculating polymer, and further increases to over 5 kPa within 1 day of compression under 0.15 bar. After about 1 to about 3 weeks compression under this pressure, the dewatered MFT may reach a solid content above about 70 wt % and an un-drained shear strength of over 10 kPa, which meets the criteria to be considered reclaimable MFT. The dewatered MFT is cohesive during the compression process and does not stick to the press.

In one embodiment, the aqueous MFT may have a solid content of about 30 wt % or more, and possess a fine to sands ratio of 100%, but can also be any other kinds of tailings from oil sands operations or other industrial tailings/slurries, including without limitation, mature fine tailings, extraction tailings, fluid fine tailings, and mine tailings/slurries.

In one embodiment, the flocculating polymers of the present invention have a solubility which is thermoresponsive in that they show an upper critical solution temperature (“UCST”) at standard or atmospheric pressure. UCST refers to the temperature above which the polymers are hydrophilic and are generally soluble (greater than about 10 g/L), and below which the polymers are more hydrophobic and less soluble (or insoluble) in water. Solubility below the UCST may vary with temperature. As shown in FIG. 14, a 0.5% (wt) solution of Polymer A (described below) in water has a UCST of about 28° C. at standard pressure. Above the UCST, it is completely soluble in water. Below the UCST, its solubility varies as a function of temperature. As may be seen, transmittance of visible light declines to about less than about 80% at 25° C., and below about 30% at 19° C. As used herein, a polymer has an UCST if it is water-soluble (>10 g/L) at and above the UCST, and has a temperature dependent solubility below the UCST. In one embodiment, the polymer having an UCST is at least 20% less soluble at a temperature which is between about 5-10 degrees less than the UCST.

In one embodiment, the polymers are copolymers synthesized from a combination of at least two different monomers, one of which is water-soluble, and the other of which is less-soluble or insoluble. As used herein, a “water-soluble monomer” is a monomer which has a solubility of 50 g/L or more (at 20° C.), preferably greater than 100 g/L, or more preferably greater than about 200 g/L.

Examples of the water-soluble monomers include acrylamide, methacrylamide, N-acryloylglycinamide, N-acryloylasparagineamide, methacryloylasparagineamide, N-acryloylglutamineamide, ureido-derivatized monomer, vinyl amine, or 1-vinyl-2-(hydroxylmethyl)imidazole, or combinations thereof. In one embodiment, acrylamide and methacrylamide are suitable.

A less-soluble or insoluble monomer is one that is at least 20%, preferably at least 30% and more preferably at least 50% less soluble than the water-soluble monomer it is combined with. Examples of less-soluble or insoluble monomers include acrylonitrile; methacrylonitrile; alkyl methacrylate and alkyl acrylate such as methyl methacrylate and methyl acrylate, ethyl methacrylate and ethyl acrylate, butyl methacrylate and butyl acrylate, ethylhexyl methacrylate and ethylhexyl acrylate; vinyl acetate; alkyl methacrylamide and alkyl acrylamide such as methyl methacrylamide and methyl acrylamide, ethyl methacrylamide and ethyl acrylamide, butyl methacrylamide and butyl acrylamide, ethylhexyl methacrylamide and ethylhexyl acrylamide; styrene and its derivatives; and N-vinylimidazole and its derivatives, or combinations thereof. In one embodiment, acrylonitrile, alkyl acrylate, or styrene and its derivatives are used.

Table 1 shows a number of exemplary monomers and their solubility in water.

TABLE 1

| Water-soluble monomers | | | Less-soluble Monomers | | |
|---|---|---|---|---|---|
| | Temperature | Solubility | | Temperature | Solubility |
| Monomer | (Celsius) | (g/L) | Monomer | (Celsius) | (g/L) |
| Acrylamide | 25 | 2040 | Acrylonitrile | 20 | 70 |
| Methacrylamide | 20 | 202 | Methacrylonitrile | 20 | 30 |
| N-Acryloyl glycinamide | 25 | 206.2* | methyl methacrylate | 20 | 16 |
| N-Acryloyl | 25 | >206.2* | methyl acrylate | 20 | 60 |
| asparagineamide | | | | | |
| Methacryloyl | N/A | Unknown | ethyl methacrylate | N/A | Not Soluble |
| asparagineamide | | | | | |
| N-acryloyl glutamineamide | 25 | >206.2* | ethyl acrylate | 20 | 15 |
| Vinyl amine | 25 | 1000* | butyl methacrylate | Not Listed | 6 |
| 1-vinyl-2- | 25 | 88.99* | butyl acrylate | Not Listed | 14 |
| (hydroxylmethyl)imidazole | | | | | |
| | | | ethylhexyl methacrylate | Not Listed | “None” |
| | | | ethylhexyl acrylate | Not Listed | “None” |
| | | | vinyl acetate | 20 | 25 |
| | | | methyl methacrylamide | 25 | 87.17* |
| | | | methyl acrylamide | 25 | 250.1* |
| | | | ethyl methacrylamide | N/A | <87.17* |
| | | | ethyl acrylamide | 25 | 74.69* |
| | | | butyl methacrylamide | N/A | <87.17* |
| | | | butyl acrylamide | N/A | <87.17* |
| | | | ethylhexyl | N/A | <87.17* |
| | | | methacrylamide | | |
| | | | ethylhexyl acrylamide | N/A | <87.17* |
| | | | styrene | 20 | 0.3 |
| | | | N-vinylimidazole and its | 25 | 18.37* |
| | | | derivatives | | |

*Estimated or predicted using the US Environmental Protection Agency's Estimation Program Interface (“EPI”) suite (http://www.epa.gov/opptintr/exposure/pubs/episuite.htm)

The flocculating polymers in this invention may have a content of less soluble or insoluble monomer constituents between about 1 to about 50 mol %, preferably between about 5 to about 30 mol %. As well, the flocculating polymers may have a weight-average molecular weight (M_{W}) between about 5000 and about 3×10⁷ Dalton, preferably higher than about 1×10⁶ Dalton.

The polymer may be formed by standard polymerization methods well known to those skilled in the art, such as free radical polymerization or living polymerization (i.e., atom transfer radical polymerization (ATRP) and reversible addition fragmentation chain transfer (RAFT) polymerization. The polymers of the present invention may be synthesized in different polymer structures such as linear polymer or block polymer, star polymer, bottle brush polymer, hyperbranched/dendrimer polymer or polymer microgel, or other structures known to those skilled in the art. In one embodiment, the polymer is a linear polymer with an UCST between about 0° C. and about 80° C.

The flocculating polymers may be in the form of solids (bulk, granules or powder). The polymers may be added to MFT in solid forms or as an aqueous solution. If in the aqueous solution form, the polymers may be prepared at a concentration of about 0.1 to about 5.0 wt %, preferably about 0.5 wt %. The dosage of polymer required for maximum dewatering efficiency may be decided by measuring the solid content of MFT. The dosage of polymer may range from about 0.1 kg/t to 20 kg/t of MFT solid content. Preferably, the dosage of polymers may be about 1 to about 10 kg/t, wherein kg/t is kg polymer per metric tonne of dry solids in MFT. As MFT typically is a slurry which contains about 30 wt % solids, the polymer dosages may be 0.03 kg/t to 6 kg/t of aqueous MFT slurry.

Preferably, the flocculating polymers are prepared in the form of an aqueous solution. In one embodiment, the mixture of flocculating polymer and MFT may be heated to a suitable temperature ranging from about 20° C. to about 80° C., preferably above the UCST, which may ensure that the polymers are completely or substantially dissolved, facilitating more homogeneous mixing between the polymers and MFT. A homogenous mixture of the polymers and MFT is desirable for maximum dewatering efficiency with minimum polymer consumption. Homogeneous mixing of polymer flocculated oil sands tailing slurries may be accomplished by using mixing tanks with impellers, or in pipelines by in-line mixers or other mechanical means well-known to those skilled in the art.

An immediate (less than about 30 minutes) release of a large fraction of clear water can be achieved when the flocculating polymers and MFT are mixed. In one test, dewatered MFT was placed in a sealed jar and continuously released water. By removing the released water once a day, the solid content of the sediment reached 50-55 wt % in 7 days, without air drying.

In one embodiment, no pre-treatment of the MFT is required, and the dewatering and densification results are repeatable and independent of weather and season.

In one embodiment, the flocculated or dewatered MFT may be further dewatered and densified, to produce a trafficable and reclaimable product. After removal of the initial released water, the dewatered MFT is then converted to a solid product (reclaimable MFT) by additional dewatering. For example, the dewatered MFT may be deposited on a slope to allow the release of more water. Alternatively, the dewatered MFT may be filtered, or subjected to a mild compression which causes more water release and generates compressed cakes with solid content over about 70 wt % and shear strengths over about 10 kPa, which are ready for reclamation. The time scale of the dewatering and densification process to convert the dewatered MFT to reclaimable MFT may be within about 1 to about 3 weeks.

Alternatively, the polymer treated MFT may be transported onto a perforated moving belt on which water can be gravity separated from the treated MFT. For example, on a laboratory scale, 35%-50% net water release was achieved by placing the polymer treated MFT on an ordinary kitchen strainer for 30 min. The turbidity of released water was 600-1100 NTU and the solid content of the dewatered MFT reached 45-50 wt % after 30 min dewatering on the kitchen strainer.

The polymer treated MFT may be compressed by self-weight or by a roller press, wherein a large fraction of water can be released further and separated from the dewatered MFT within a short period of time. It has been observed that the sediments are cohesive and do not stick to the press during compression. At a pressure of 0.15 bar above atmospheric, the sediment solid content reached over 52 wt % within 24 hours. Within 7 days, the treated MFT may reach a shear stress of greater than 10 kPa. Within 14 days, the original MFT may be transformed to reclaimable MFT with a solid content above 70 wt %.

The polymers provide higher shear strength performance of the MFT (immediately after treatment) than other polymer flocculants known in the prior art, such as hydrolyzed polyacrylamide (30% anionicity), starch, chitosan, and polyethylene oxide. When the solid content of the sediment reaches over 52 wt %, the shear strength may be higher than 5 kPa and, when the solid content of the sediment reaches over 55-60 wt %, the shear strength may be higher than 10 kPa.

The released water during the dewatering process has a solid content of less than 1 wt %, preferably less 0.5 wt %, and more preferably 0.2 wt %. With such low solid content, the released water may be used for preparing more polymer solutions or recycling to the oil sands extraction process.

The use of the polymer does not pose any additional environmental or health concerns of the MFT and therefore does not cause any further burden to the environment.

### EXAMPLES

The following examples are intended to be descriptive of exemplary embodiments of the invention, but not limiting of the claimed invention.

### Example 1

### Polymers and MFT

All polymers were prepared in 0.5 wt % water solution and at a suitable temperature for dissolution. Polymer A, Polymer B, Polymer C, and Polymer D are polymers of typical water-soluble monomers (e.g. acrylamide) and representative less-soluble monomers (e.g. acrylonitrile) of different ratios prepared by standard polymerization methods such as free radical polymerization or living polymerization (i.e., atom transfer radical polymerization (ATRP) and reversible addition fragmentation chain transfer (RAFT) polymerization).
Polymer A is a random copolymer of acrylamide and acrylonitrile with a molar ratio between acrylamide and acrylonitrile as 5:1
Polymer B is a random copolymer of methacrylamide, methacryloylasparagineamide, N-methacryloylglutamineamide, and styrene with the molar ratio of these components as 6:2:2:1.
Polymer C is a branched star-like random copolymer of acrylamide and acrylonitrile, where the molar ratio between acrylamide and acrylonitrile is 5:1.
Polymer D is a block polymer possessing one block of polyethylene oxide (PEO) and the other block as a random copolymer of acrylamide, N-acryloylglycinamide and butyl acrylate with molar ratio of 8:1:1.
   For comparison purposes, the following commercially available polymers were studied.
Polymer E is FLOPAM A-3338™, a branched anionic polyacrylamide (commercial polymer flocculant currently used by oil sands industry)
Polymer F is Magnafloc®1011, a linear anionic polyacrylamide (commercial polymer flocculant currently used by oil sands industry)

Mature fine tailings samples having the following solid content (wt %) were used as provided.

| Mature fine tailings | Solid content |
|---|---|
| MFT A | 29%-33% |
| MFT B | 29%-33% |
| MFT C | 20%-25% |
| MFT D | 35%-40% |
| MFT E | 55%-61% |

### Example 2

### Testing Methods

An optimum dosage of the flocculating polymers was determined by continuously adding the polymers to the MFT samples and by visually examining the clarity of the released water and the appearance of the formed flocs. The unit of polymer dosage was in kg polymer per metric tonne of MFT dry solids (kg/t).

Net water release is the ratio of the net amount of released water to the original amount of water in the MFT slurry. The net amount of released water is equal to the total amount of released water minus the amount of water brought to the MFT due to the addition of the polymer solution. The net water release is expressed as a percentage by volume. “Instant net water release” in the present description means the net water release within 30 min after adding polymer flocculants.

“Un-drained shear strength” means the shear stress or pressure required to cause the MFT (treated or untreated) to flow. In the present description, the term “un-drained shear strength”, “yield shear stress”, “shear strength” and similar terms are interchangeably used. The shear strength of the sediments was measured on a rheometer using a stainless steel vane. The vane geometry was a four-bladed paddle with a diameter of 21 mm, the outer cup diameter was 60 mm and its depth was 100 mm. The measurement was carried out according to Pacific Northwest National Laboratory (PNNL-19094) procedure for cohesive soil.

### Example 3

### Small Scale Laboratory Tests

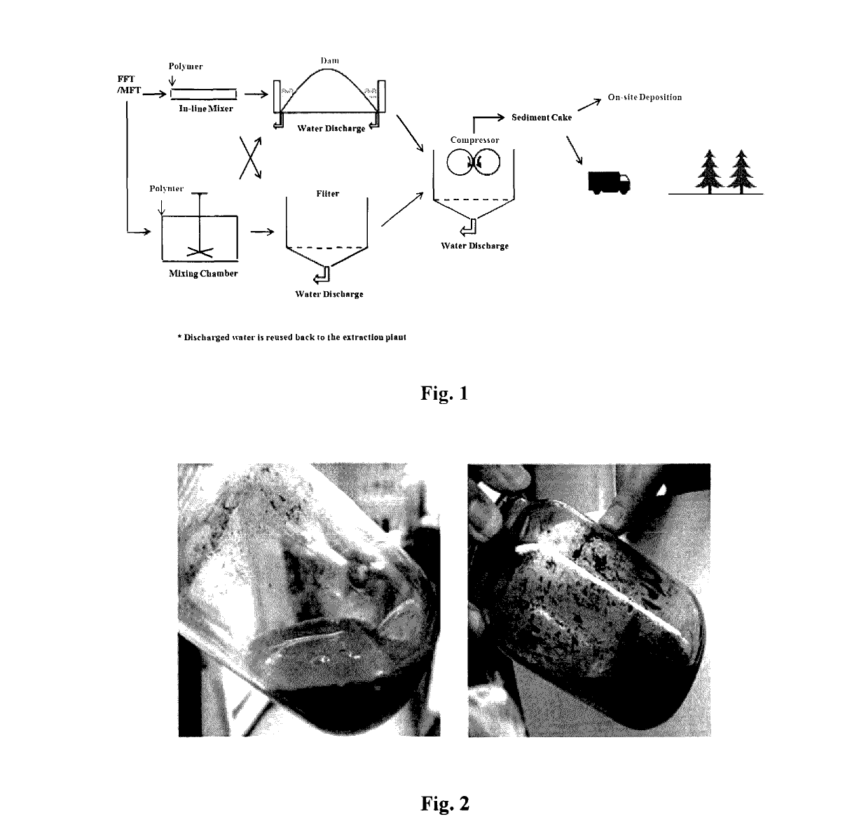

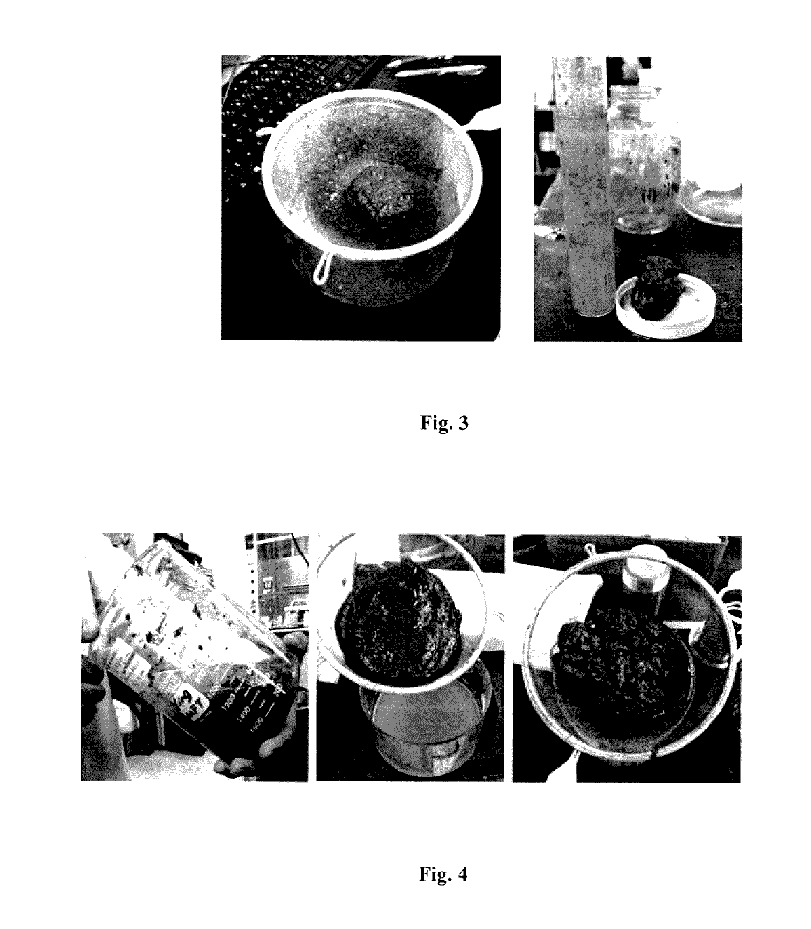

The dewatering performance of polymers A to D was evaluated by small scale settling tests on MFT A, and was compared to the two prior art commercial flocculants polymers E and F. Each of the polymers A to D was prepared in 0.5 wt % aqueous solution using deionized water; whereas polymers E and F was prepared in 0.45 wt % aqueous solution. In each test, 100 g MFT A were thoroughly homogenized by mechanical agitation at 600 rpm for 1 min in a 250 mL beaker. The polymer solution was then continuously added to the tailings under a mixing speed of 300 rpm. The polymer addition and mixing were stopped when the slurry was visually phase separated into a clear water phase and a sediment phase (FIG. 2). The water-sediment mixture was then placed on a kitchen strainer (aperture diameter 1-3 mm) for 30 min to remove the released water (FIG. 3). Even at an optimal polymer dosage, Polymer E and Polymer F added MFT did not release water in 30 minutes. There was no visible flocculation.

As shown in Table 2, the instantaneous net water release when using polymers A to D was about 30-40%, in contrast to the negative net water release observed for polymers E and F. Accordingly, polymers A to D gave much higher sediment solid contents and therefore a higher shear strength of the sediment than polymers E and F. After 1-3 weeks dewatering under the 0.15 atmospheric pressure, the shear strength of the sediments obtained from using polymers A to D was much higher than 10 kPa. The solid content of released water for polymers A to D was significantly less than that for polymer E and F, indicating a better quality of the released water.

TABLE 2
Dewatering and densification performance of the polymers - small scale tests.

| | | | | Solid | | Shear |
|---|---|---|---|---|---|---|
| | | Instantaneous | Solid Content | Content in | Instantaneous | Strength |
| Polymer | Dosage | Net Water | in Released | Sediments | Shear Strength | after three |
| Type | (kg/t) | Release (%) | Water | (wt %) | (Pa) | weeks |
| Polymer A | 10 | 42 | <0.2 wt % | 43 | 1436 | >10 kPa |
| Polymer B | 10 | 32 | | 38 | 852 | |
| Polymer C | 10 | 23 | | 36 | 667 | |
| Polymer D | 10 | 41 | | 42 | 1256 | |
| Polymer E | 1.2* | 0 | >3 wt % | 31 | 72 | <2 kPa |
| Polymer E | 1.6* | 4 | | 32 | 194 | |
| Polymer F | 0.8* | negative | N/A (not | 27 | 23 | |
| Polymer F | 1.2* | negative | enough water | 25 | | |
| | | | released for | | | |
| | | | measurement) | | | |

*These polymer dosages are the optimum one for these commercial polymers to demonstrate the best dewatering performance on treating MFT. Higher dosages of these commercial polymer flocculants (e.g, 10 kg/t) only results in a worse performance or only a dilution effect on MFT.

### Example 4

### Intermediate Scale Lab Tests

Intermediate scale settling test was conducted following similar procedures as the small scale settling test. Briefly, 0.5 wt % polymer A or polymer B solution was dispersed to 500 g MFT A in a 2.5 L beaker under a mixing speed of 300 rpm. Polymer addition and mixing was stopped when the slurry was visibly phase separated into a clear water phase and a sediment phase. The water-sediment mixture was then placed on a kitchen strainer (aperture diameter 1-3 mm) for 30 min to remove the released water. FIG. 4 shows the photographic images demonstrating the test. The results of the intermediate scale tests are summarized in Table 3 and they resembled the results of small scale tests as shown in Table 2.

TABLE 3
Dewatering performance of polymers
A and B - intermediate scale tests.

| | | Instantaneous Net | Solid Content in |
|---|---|---|---|
| Polymer Type | Dosage (kg/t) | Water Release (%) | Sediments (wt %) |
| Polymer A | 5 | 43 | 45 |
| Polymer B | 5 | 42 | 42 |

### Example 5

### Large Scale Laboratory Tests

Large scale test was conducted following similar procedures as the small scale settling tests. Briefly, 0.5 wt % polymer A solution was dispersed to 10 L MFT A in a 19 L plastic bucket under vigorous agitation by a mechanical mixer. Polymer addition and mixing was stopped when the slurry was visibly phase separated into a clear water phase and a sediment phase. The treated MFT was then placed on a large kitchen strainer (aperture diameter 2-2.5 mm) for 30 min to remove released water. The results of the large scale tests (Table 4) resembled the results of small scale tests (Table 2).

TABLE 4
Dewatering performance of polymer A - large scale tests.

| Dosage | Instantaneous Net | Solid Content in | Solid Content in |
|---|---|---|---|
| (kg/t) | Water Release (%) | Released Water (wt %) | Sediments (wt %) |
| 3.5 | 43 | 0.18 | 44.6 |

### Example 6

### Small Scale Settling Tests on Various MFT

The dewatering performance of polymer A was evaluated on various un-diluted MFT samples (100 g) from different sources following the small scale settling test procedures. The results are summarised in Table 5. As can be seen from Table 5, the invented polymer dewatering and densification process was successfully applied to the different MFT samples whose original solid contents ranged from 17 wt % to 56 wt %. The dosage of polymer A showed a tendency dependent on solid content of the MFT.

TABLE 5
Dewatering and densification performance of polymer A on various MFT samples.

| | | | | Solid | | | |
|---|---|---|---|---|---|---|---|
| | Original | | | Content | Solid | | Shear |
| | Solid | Polymer | Instantaneous | in | Content in | Instantaneous | Strength |
| MFT | Content | Dosage | Net Water | Released | Sediments | Shear Strength | after three |
| Type | (wt %) | (kg/t) | Release (%) | Water | (wt %) | (Pa) | weeks |
| MFT B | 29%-33% | 6 | 40 | <0.2 wt % | 42 | 1674 | >10 kPa |
| MFT C | 20%-25% | 8 | 53 | | 40 | 1170 | >10 kPa |
| MFT D | 35%-40% | 7 | 22 | | 35 | 731 | >10 kPa |
| MFT E | 55%-61% | 5 | negative | <1 wt % | 27 | 694 | >10 kPa |

### Example 7

### Compression of Dewatered MFT

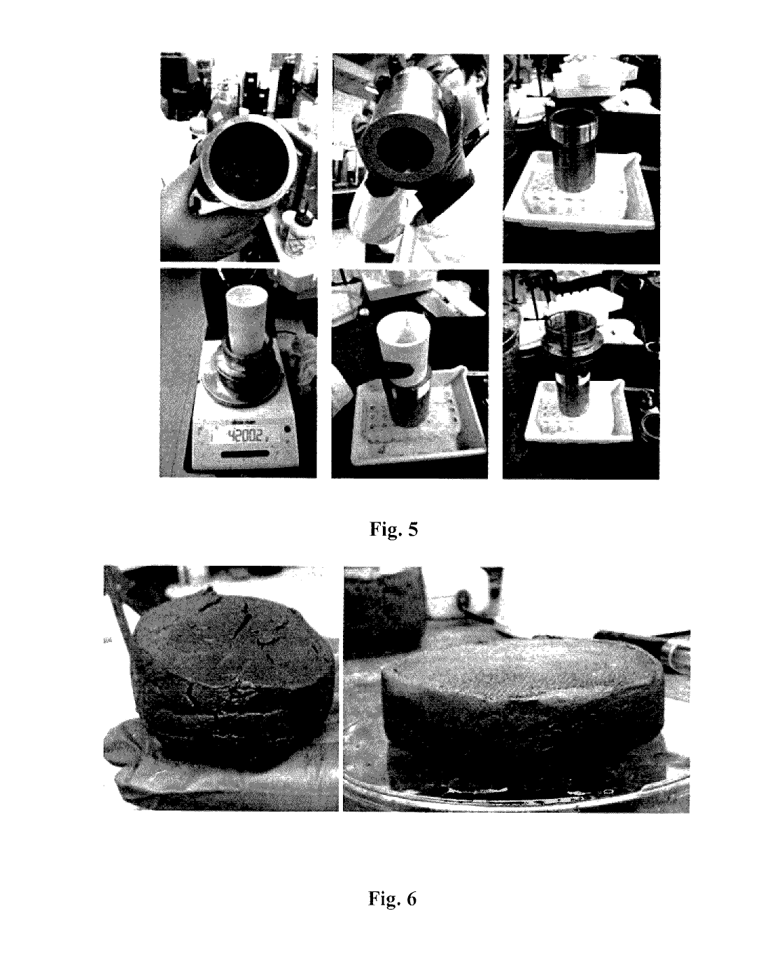

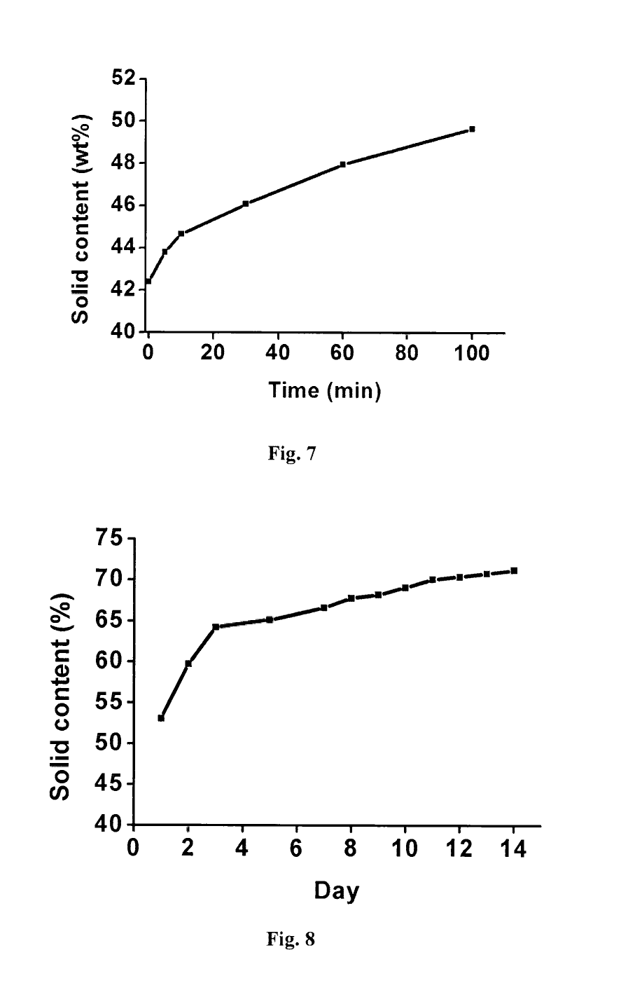

In this experiment, the dewatered MFT on the kitchen strainer after 30 min was subjected to compression to release more water. The dewatered MFT was from a small scale settling test of polymer B (dosage: 6.0 kg/t) on MFT A. FIG. 5 demonstrates the compression experiment setup using a mass of 4.2 kg to compress the dewatered MFT. The effective contact area is 0.00059 m², so that the pressure is 0.15 kg/cm², i.e., 15% of atmosphere pressure. FIG. 6 shows the compressed cake after 1 day and 14 days of compression. Changes in the solid content of the compressed cake in a short time (100 min) and in a relatively longer time period (14 days) are shown in FIG. 7 and FIG. 8, respectively. After 100 min of compression, the solid content of the cake reached 50 wt %, and after 14 days of compression, the solid content reached over 70 wt %. Therefore, the original MFT was converted to reclaimable MFT in 14 days.

### Example 8

### Long Term Water Release in Sealed Jars

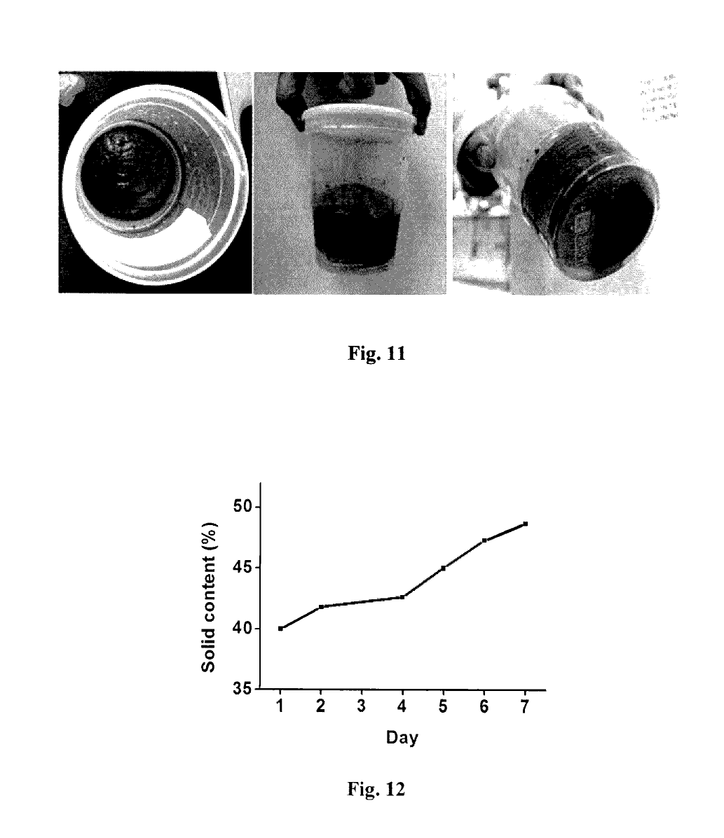

In this example, 300 g MFT B was treated by 5 kg/t polymer A and subjected to the kitchen strainer dewatering for 10 min, and the dewatered MFT was stored in a sealed jar to allow for gravity sedimentation and further water release. As shown in FIG. 11, more water was continuously released from the dewatered MFT. The released water was removed once a day by placing the sediment on the kitchen strainer for about 5 sec before weighing. Within a week, the solid content of the sediment increased from about 40 wt % to about 50 wt % as shown in FIG. 12.

### Example 9

### Vacuum Filtration Performance

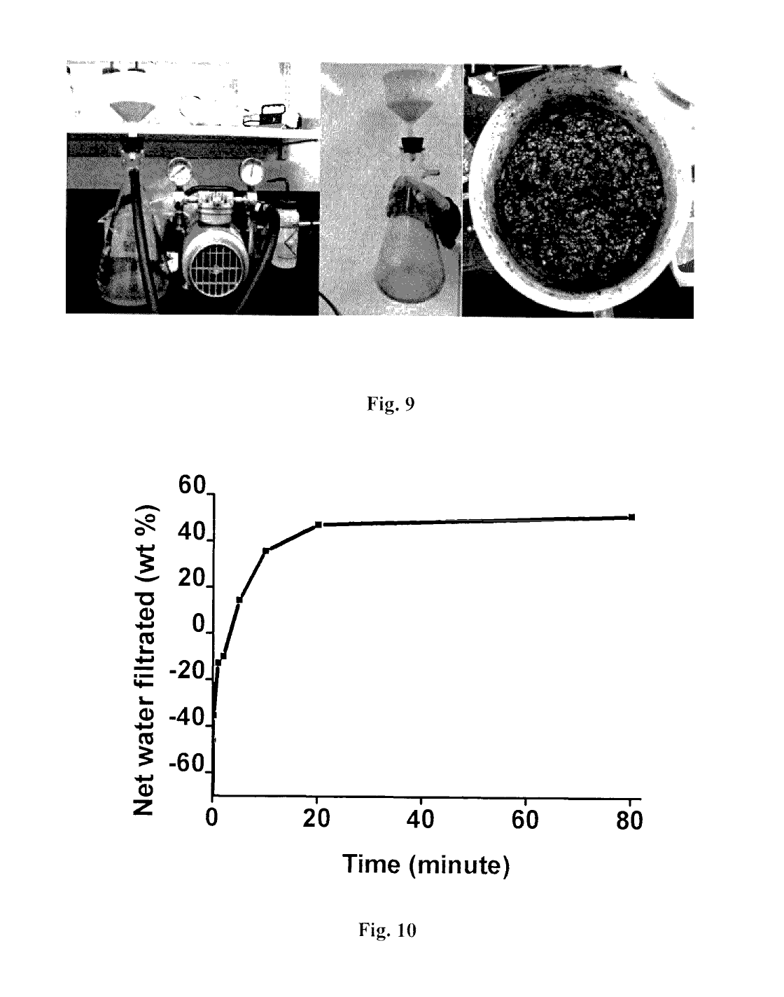

Vacuum filtration of treated MFT was conducted by a laboratory vacuum filtration setup which included a laboratory vacuum pump, a filter flask, Buchner funnel, tubing, and filter paper (grade P8, Fisherbrand) under a constant pressure of 60 kPa. Briefly, 100 g MFT A were treated by about 9.0 kg/t Polymer A, and was then subjected to filtration (demonstrated in FIG. 9). The filtrate (water) volume was recorded as a function of filtration time as shown in FIG. 10. In about 20 min of filtration, the net water release was about 50%. Note: after about 20 mins, cracks were formed in the filter cake, and the vacuum was significantly dropped, at which point the net water release reached about 50%.

### Example 10

### Shear Strength Performance

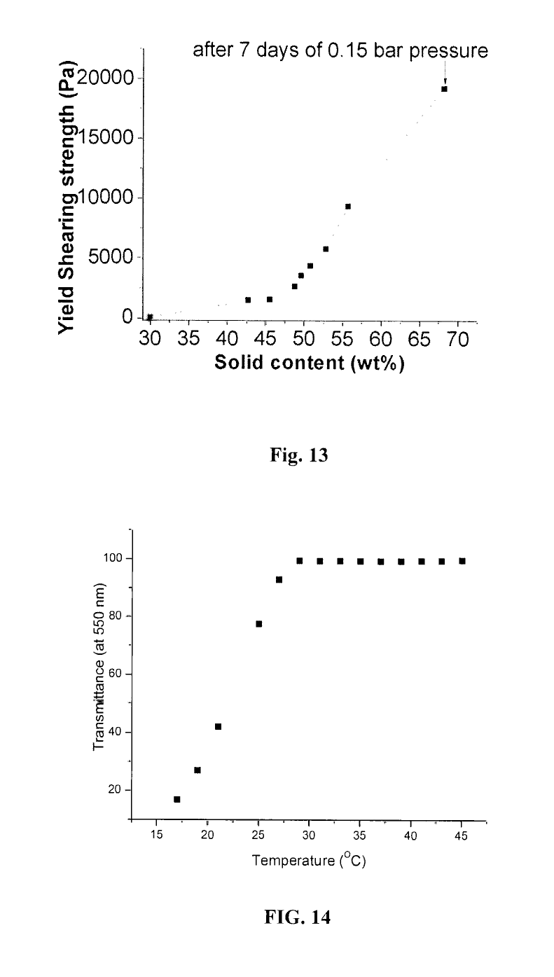

The shear strength of the dewatered MFT as a function of solid content, after 7 days of mild compression, is shown in FIG. 13. As may be seen at a solids content of 65% or higher, a shear strength of about 15 kPa is reached.

### DEFINITIONS AND INTERPRETATION

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skilled in the art, particularly when read in context of its usage.

The term “about” can refer to a variation of ±5%, ±10%, ±20%, or ±25% of the value specified. For example, “about 50 percent” can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A method of treating a solid particulate suspension to form a flocculated slurry, comprising the steps of mixing the suspension with a polymer having a solubility in water which is temperature responsive, having an upper critical solution temperature between about 0° C. and about 80° C.

2. The method of claim 1 wherein the polymer comprises water-soluble monomer units and monomers units which are insoluble or less-soluble in water than the water-soluble monomers.

3. The method of claim 2 wherein the polymer has a content of less soluble or insoluble monomer constituents between about 1 to about 50 mol %.

4. The method of claim 3 wherein the polymer has a content of less soluble or insoluble monomer constituents between about 5 to about 30 mol %.

5. The method of claim 1 wherein the polymer has a weight-average molecular weight between about 5000 and about 3×10⁷ Dalton.

6. The method of claim 5 wherein the polymer has a weight-average molecular weight greater than about 1×10⁶ Dalton.

7. The method of claim 1 wherein the slurry comprises mature fine tailings (MFT) from an oil sands operation.

8. The method of claim 7 further comprising the step of dewatering the flocculated slurry to produce a dewatered MFT.

9. The method of claim 8 comprising the further step of producing a reclaimable MFT by slope deposition, gravity settling, filtration, screening, high pressure grinding roller (HPGR) compression, or other mode of compression, or combinations thereof.

10. The method of claim 8 which produces a reclaimable MFT having a solids content greater than about 70% (wt.) and/or a shear strength greater than about 10 kPa

11. The method of claim 9 wherein the reclaimable MFT is produced within 3 weeks.

12. The method of claim 7 wherein the polymer is added to the MFT without any pre-treatment of the MFT.

13. The method of claim 2 wherein the less-soluble or insoluble monomer is one that is at least 20% less soluble than the water-soluble monomer it is combined with.

14. The method of claim 13 wherein the less-soluble or insoluble monomer is one that is at least 30% or 50% less soluble than the water-soluble monomer it is combined with.

15. The method of claim 2 wherein the water-soluble monomers comprise one or more of acrylamide, methacrylamide, N-acryloylglycinamide, N-acryloylasparagineamide, methacryloylasparagineamide, N-acryloylglutamineamide, ureido-derivatized monomer, vinyl amine, or 1-vinyl-2-(hydroxylmethyl)imidazole.

16. The method of claim 15 wherein the less-soluble or insoluble monomers comprise one or more of acrylonitrile; methacrylonitrile; alkyl methacrylate and alkyl acrylate such as methyl methacrylate and methyl acrylate, ethyl methacrylate and ethyl acrylate, butyl methacrylate and butyl acrylate, ethylhexyl methacrylate and ethylhexyl acrylate; vinyl acetate; alkyl methacrylamide and alkyl acrylamide such as methyl methacrylamide and methyl acrylamide, ethyl methacrylamide and ethyl acrylamide, butyl methacrylamide and butyl acrylamide, ethylhexyl methacrylamide and ethylhexyl acrylamide; styrene and its derivatives; and N-vinylimidazole and its derivatives.

17. The method of claim 1 wherein the polymer comprises:
a. a random copolymer of acrylamide and acrylonitrile with a molar ratio between acrylamide and acrylonitrile as 5:1;
b. a random copolymer of methacrylamide, methacryloylasparagineamide, N-methacryloylglutamineamide, styrene with the molar ratio of these components as 6:2:2:1;
c. a star-like copolymer with branches as a random polymer of acrylamide and acrylonitrile, where the molar ratio between acrylamide and acrylonitrile is 5:1; or
d. a block polymer possessing one block of polyethylene oxide (PEO) and the other block as a random copolymer of acrylamide, N-acryloylglycinamide and butyl acrylate with molar ratio of 8:1:1.
